(19) United States
(12) Patent Application Publication
(10) Pub. No.: US 2013/0094472 A1
(43) Pub. Date: Apr. 18, 2013

(54) METHODS AND APPARATUSES FOR REDUCING VOICE/DATA INTERRUPTION DURING A MOBILITY PROCEDURE

(71) Applicant: QUALCOMM INCORPORATED, San Diego, CA (US)

(72) Inventors: Thomas Klingenbrunn, San Diego, CA (US); Navid Ehsan, San Diego, CA (US); Fahed I. Zawaideh, San Diego, CA (US); Yi Cheng, San Diego, CA (US)

(73) Assignee: QUALCOMM INCORPORATED, San Diego, CA (US)

(21) Appl. No.: 13/649,436

(22) Filed: Oct. 11, 2012

Related U.S. Application Data
(60) Provisional application No. 61/547,561, filed on Oct. 14, 2011.

(51) Int. Cl. H04W 36/02

(52) U.S. Cl. CPC H04W 36/023
USPC 370/331

(57) ABSTRACT

Method and apparatus are provided that may help improve user experience during a media session when a mobility procedure of a user equipment (UE) involved in the session causes disruption in reception of packets. According to certain aspects, upon detecting an event indicating a mobility procedure is likely to occur, the UE may increase size of a buffer used to store packets during the session and/or reduce the rate at which packets are played out from the buffer to reduce service (e.g., voice/data) interruption.

### CLAIM OF PRIORITY UNDER 35 U.S.C. §119

The present application for patent claims priority to U.S. Provisional Application No. 61/547,561, entitled, “Methods and Apparatuses for Reducing Voice Interruption During a Mobility Procedure,” filed Oct. 14, 2011, and assigned to the assignee hereof and hereby expressly incorporated by reference herein.

### TECHNICAL FIELD

Certain aspects of the present disclosure generally relate to mobility procedures, and in particular, to methods and systems for reducing voice interruption while performing mobility procedures.

### BACKGROUND

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3rd Generation Partnership Project (3GPP) Long Term Evolution (LTE) systems, Orthogonal Frequency Division Multiple Access (OFDMA) systems, and the like.

Single radio voice call continuity (SRVCC) provides the ability to transition a voice call from a packet domain (e.g., voice over internet protocol (VoIP) or IP multimedia subsystem (IMS)) to the legacy circuit domain. Variations of SRVCC may support Global System for Mobile Communications (GSM)/Universal Mobile Telecommunications System (UMTS) and CDMA 1x circuit domains. For an operator with a legacy cellular network who wishes to deploy internet protocol (IP) multimedia subsystem (IMS) and voice over IP (VoIP)-based voice services in conjunction with the rollout of a long term evolution (LTE) network, SRVCC may offer VoIP subscribers with coverage over a much larger area than would typically be available during the rollout of a new network.

### SUMMARY

Certain aspects of the present disclosure provide a method for wireless communications by a user equipment (UE). The method generally includes detecting an event that indicates an expected disruption in reception of packets is likely to occur during a media session due to an expected mobility procedure, and in response to the detection, increasing buffering of packets during the session by adjusting size of a buffer used to buffer packets during the media session and decreasing a rate at which packets are transferred from the buffer.

Certain aspects of the present disclosure provide an apparatus for wireless communications. The apparatus generally includes means for detecting an event that indicates an expected disruption in reception of packets is likely to occur during a media session due to an expected mobility procedure, and in response to the detection, means for increasing buffering of packets during the session by adjusting size of a buffer used to buffer packets during the media session and decreasing a rate at which packets are transferred from the buffer.

Certain aspects provide a computer-program product for wireless communications, comprising a computer-readable medium having instructions stored thereon, the instructions being executable by one or more processors. The instructions generally include instructions for detecting, by a user equipment (UE), an event that indicates an expected disruption in reception of packets is likely to occur during a media session due to an expected mobility procedure, and in response to the detection, instructions for increasing buffering of packets during the session by adjusting size of a buffer used to buffer packets during the media session and decreasing a rate at which packets are transferred from the buffer.

Certain aspects of the present disclosure provide an apparatus for wireless communications. The apparatus generally includes at least one processor and a memory coupled to the at least one processor. The at least one processor is generally configured to detect an event that indicates an expected disruption in reception of packets is likely to occur during a media session due to an expected mobility procedure, and in response to the detection, increase buffering of packets during the session by adjusting size of a buffer used to buffer packets during the media session and decreasing a rate at which packets are transferred from the buffer.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain aspects of the present disclosure.

FIG. 2 is a block diagram of a communication system, in accordance with certain aspects of the present disclosure.

FIG. 3 illustrates an example single radio voice call continuity (SRVCC) procedure.

FIG. 4 illustrates example operations that may be performed by a user equipment to reduce voice interruption during a mobility procedure, in accordance with certain aspects of the present disclosure.

FIG. 5 illustrates an example wireless network, in accordance with certain aspects of the present disclosure.

FIG. 6 illustrates an example call flow for SRVCC procedure from Evolved Universal Terrestrial Radio Access Network (E-UTRAN) to GERAN (Global System for Mobile Communications (GSM) Enhanced Data GSM Environment (EDGE) Radio Access Network), in accordance with certain aspects of the present disclosure.

FIG. 7 illustrates an example user equipment, in accordance with certain aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, an evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). Code division multiple access (CDMA2000) covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency. SC-FDMA is currently a working assumption for uplink multiple access scheme in 3GPP Long Term Evolution (LTE), or Evolved UTRA.

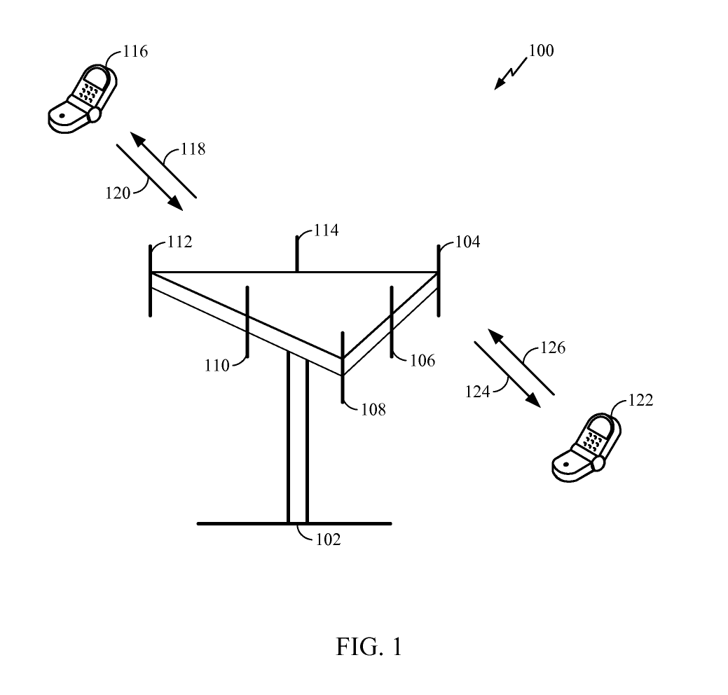

Referring to FIG. 1, a multiple access wireless communication system 100 according to one aspect is illustrated. Access terminals 116 and 122 may perform operations described herein. An access point 102 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 118 and receive information from access terminal 116 over reverse link 120. Access terminal 122 is in communication with antennas 104 and 106, where antennas 104 and 106 transmit information to access terminal 122 over forward link 124 and receive information from access terminal 122 over reverse link 126. In a Frequency Division Duplex (FDD) system, communication links 118, 120, 124 and 126 may use a different frequency for communication. For example, forward link 118 may use a different frequency than that used by reverse link 120.

Each group of antennas and/or the area in which they are designed to communicate is often referred to as a sector of the access point. In an aspect, antenna groups each are designed to communicate to access terminals in a sector of the areas covered by access point 102.

In communication over forward links 118 and 124, the transmitting antennas of access point 102 utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

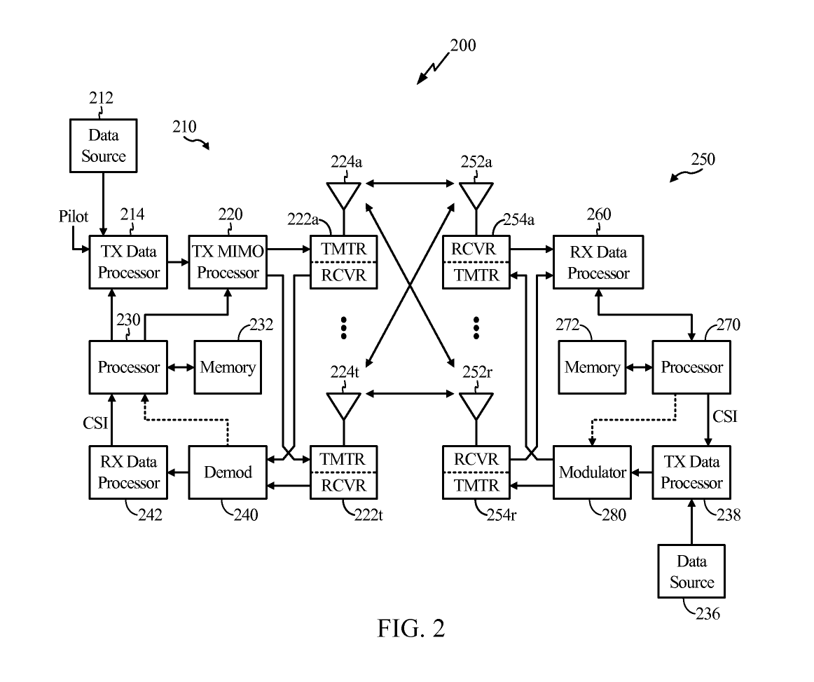

FIG. 2 is a block diagram of an aspect of a transmitter system 210 (also known as the access point) and a receiver system 250 (also known as the access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., binary phase shift keying (BPSK), Quadrature phase shift keying (QPSK), M-PSK, or M-QAM (Quadrature Amplitude Modulation), in which M may be a power of two) selected for that data stream to provide modulation symbols. The data rate, coding, and modulation for each data stream may be determined by instructions performed by processor 230 that may be coupled to the memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270, which may be coupled to the memory 272, periodically determines which pre-coding matrix to use. Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Processors 230 and 270 can direct (e.g., control, coordinate, manage, etc.) operation at base station 210 and mobile device 250, respectively. Respective processors 230 and 270 can be associated with memory 232 and 272 that store program codes and data. Processors 230 and 270 can also perform computations to derive frequency and impulse response estimates for the uplink and downlink, respectively. All “processor” functions can be migrated between and among process modules such that certain processor modules may not be present in certain embodiments, or additional processor modules not illustrated herein may be present.

Memory 232 and 272 (as with all data stores disclosed herein) can be either volatile memory or nonvolatile memory or can include both volatile and nonvolatile portions, and can be fixed, removable or include both fixed and removable portions. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink™ DRAM (SLDRAM), and direct Rambus™ RAM (DRRAM). Memory of the certain embodiments is intended to comprise, without being limited to, these and any other suitable types of memory.

### Example Methods for Reducing Voice or Data Interruption During a Mobility Procedure

Certain aspects of the present disclosure provide techniques that may be applied to wireless devices to reduce voice and/or data interruption during a mobility procedure performed by the wireless device itself or by another device that is involved in a media session with the wireless device. The mobility procedure may include a handover in the same radio access technology (RAT) network or a handover to a different RAT network (e.g., inter-RAT handover). For certain aspects, the device may be using single radio voice call continuity (SRVCC) procedure. Techniques described herein may be applied at both near-end wireless devices or user equipment (UEs) (e.g., those affected by the mobility procedure) and far-end UEs (e.g., those involved in a media session with the near-end UEs subject to the mobility procedure). By detecting an event that indicates a mobility procedure (and a corresponding disruption in packet reception) is likely to happen, the UEs may take one or more actions, such as increasing buffering of packets and slowing down the play-out of packets, and the like. These actions may help reduce the impact on the user experience caused by the disruption in packet reception due to the mobility procedure.

Single radio voice call continuity (SRVCC) procedures may enable a UE to maintain voice call continuity when switching between packet switched (PS) access and circuit switched (CS) access. The SRVCC may be used when the UE is capable of transmitting/receiving on only one of the PS or CS access networks at a given time. For example, the UE may utilize SRVCC procedures to switch between Evolved Universal Terrestrial Radio Access Network (E-UTRAN) and 3GPP UTRAN and/or between E-UTRAN and 3GPP GERAN (Global System for Mobile Communications (GSM) Enhanced Data GSM Environment (EDGE) Radio Access Network).

Certain examples described herein involve SRVCC as a specific, but not limiting, example of a mobility procedure that may lead to disruption in packet reception. However, those skilled in the art will appreciate that the techniques presented herein may more generally be applied to a wide variety of mobility procedures. Such mobility procedures may include but are not limited to handover of a UE from a packet-based radio access technology (RAT) network to a non-packet-switched RAT (e.g., circuit switched), handover between different packet-based RAT networks, or intra-RAT handover where a UE is handed over between base stations within the same RAT, or even inter-frequency handovers where a UE is moved between different frequencies.

The techniques presented herein may be applied during media sessions involving handovers between any types of RAT, such as LTE, CDMA, wide band code division multiple access (WCDMA), high rate data packet (HRPD), evolved HRPD (eHRPD), high speed packet access (HSPA), evolved HSPA (eHSPA), evolved data optimized (EV-DO), wireless local area network (WLAN), Worldwide Interoperability for Microwave Access (WiMAX) network, and the like.

Similarly, while examples described herein involve Voice over Internet Protocol (VoIP) sessions involving packet-based RAT networks, such as Voice over LTE (VoLTE), the techniques may more generally be applied to any type of media session (e.g., video telephony) in which packet reception may be disrupted due to a mobility procedure.

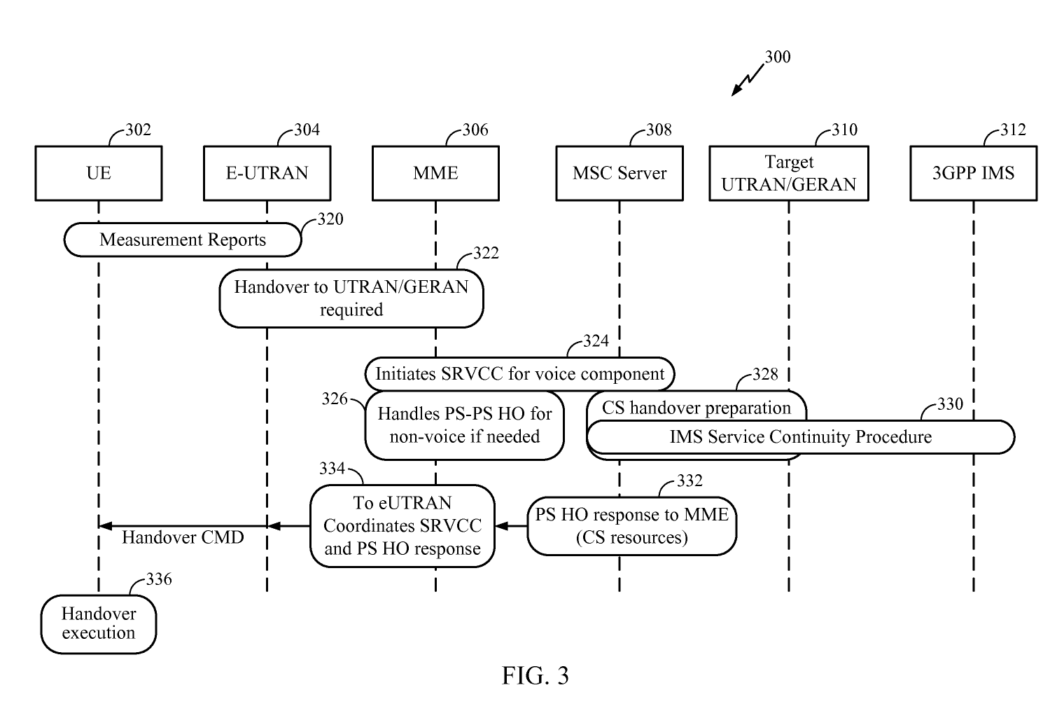

FIG. 3 illustrates an example SRVCC procedure in which techniques of the present disclosure may be utilized. As illustrated, the UE may interact with its serving base station using a radio access technology (e.g., E-UTRAN 304) and other network nodes (e.g., Mobile Management Entity (MME) 306, MSC server 308, and 3GPP Internet Protocol (IP) Multimedia Subsystem (IMS) 312). The UE may handover to a different RAT (e.g., target UTRAN/GERAN 310) if quality of the signals received from its serving base station is lower than a threshold. If the UE has an active voice/media session with another node, the UE should be able to continue the session during handover. For facilitating session transfer (e.g., SRVCC) of the voice component to the CS domain, the IMS multimedia telephony sessions may be anchored in the IMS. A UE 302 may exchange measurement reports with E-UTRAN 304. For SRVCC from E-UTRAN 304 to UTRAN/GERAN 310, the MME 306 may receive a handover request 322 from E-UTRAN 304 with an indication that this is for SRVCC handling. The MME 306 may then trigger the SRVCC procedure for voice component (e.g., at 324) with the MSC Server 308. The MME may also handle PS to PS handover for non-voice (e.g., at 326), if needed. The MSC Server 308 may initiate the session transfer procedure 330 to IMS 312 and coordinate (e.g., at 328) the session transfer with the CS handover procedure to the target UTRAN/GERAN 310. The MSC Server 308 may then send PS to CS handover Response 332 to MME, which may include the necessary CS handover command information for the UE to access the UTRAN/GERAN network.

During the SRVCC procedure, there may be voice interruption due to packet loss caused by the inter-RAT mobility procedures. Typical implementations may have a play-out buffer. However, size of the play-out buffer may be limited because a large buffer will result in larger end to end delay, which may degrade the voice experience for the end-user. The typical play-out buffer sizes (e.g., sized to buffer 40-100 ms worth of packets) may not be sufficient to cover the gap caused by the SRVCC mobility procedures. In some scenarios, this gap may be more than 200 ms. Hence, during SRVCC, the play-out buffer may be completely emptied, resulting in audio clipping, and consequently degraded user experience.

It should be noted that when an SRVCC procedure is performed, the far-end UE may suffer voice interruption similar to the voice interruption experienced at the near-end UE. Performing the SRVCC mobility procedures (e.g., from LTE to a non-packet-based network) on the near-end UE may cause voice frames to be dropped, which may result in voice interruption at both the near-end and far-end UEs.

As noted above, certain aspects of the present disclosure may help improve the user experience at both the near-end UE and the far-end UE by increasing buffer size and/or slowing down play-out in anticipation of a mobility procedure.

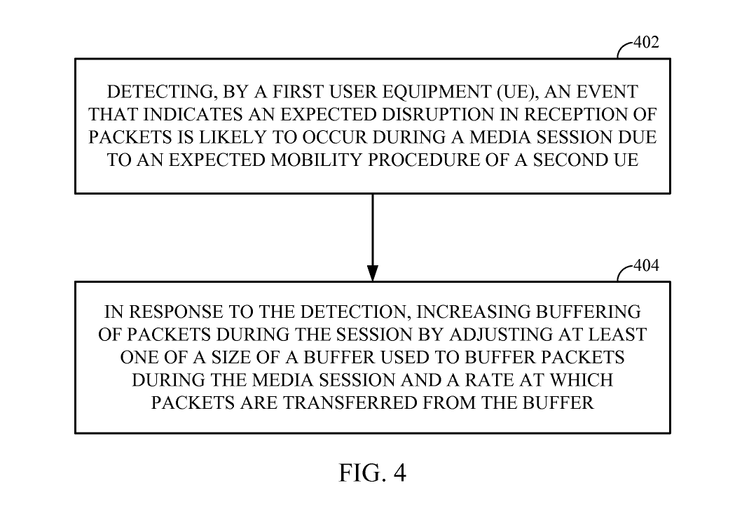

FIG. 4 illustrates example operations that may be performed by a UE to reduce packet reception interruption during a mobility procedure, in accordance with certain aspects of the present disclosure. The mobility procedures may be performed between two different RATs (e.g., inter-RAT) or in the same RAT. The operations shown in FIG. 4 may be performed by a near-end UE and/or a far-end UE, as will be described in greater detail below.

At 402, the UE may detect an event that indicates an expected disruption in reception of packets is likely to occur during a media session due to an expected mobility procedure. For certain aspects, the expected mobility procedure may be performed by either the near-end UE or the far-end UE. For certain aspects, the mobility procedure may include inter-frequency handover of the UE (e.g., near-end UE) within a same RAT network. For another aspect, the mobility procedure may include an intra-frequency handover of the UE from a first base station to a second base station. For certain aspects the mobility procedure may include a mobility procedure affecting the far-end UE involved in the media session with the UE. In this case, the event may correspond to detection of a change in a traffic flow template (TFT) as part of a remote end session transfer.

At 404, in response to the detection, the UE may increase buffering of packets during the session by adjusting size of a buffer used to buffer packets during the media session and decreasing the rate at which packets are transferred from the buffer. Exactly what type of event is detected may vary with a particular embodiment and may also depend on whether the UE is a near-end or a far-end UE. For certain aspects, the event may correspond to a reduction in signal quality of a serving base station below a threshold value. For another aspect, the event may correspond to the UE being configured to send measurement reports. For another aspect, the event may correspond to signal quality of a measured neighbor base station exceeding a threshold value.

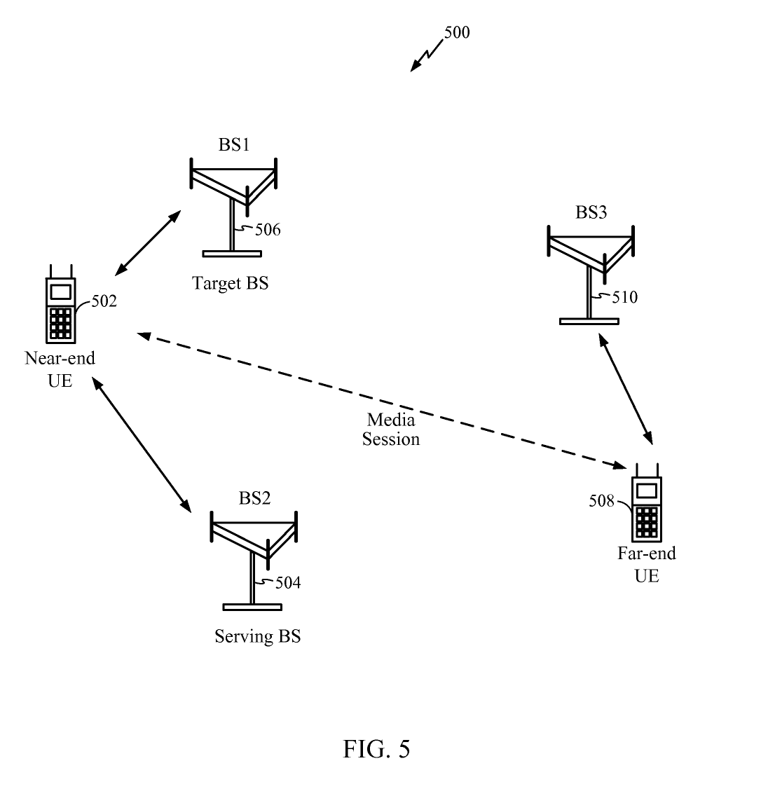

FIG. 5 illustrates an example wireless network 500 in which the proposed methods may be utilized. As illustrated, the network may include a near-end UE 502 and a far-end UE 508, a serving BS (e.g., BS1 504), a target BS (e.g., BS2 506) and a base station (e.g., BS3 510) that serves the far-end UE. The near-end UE 502 and the far-end UE 508 may be involved in a media session, such as voice (e.g., VoIP session) and/or video session, and the like. Based on the channel conditions, the near-end UE may decide to handover from its serving BS 504 to a target BS 506, while continuing the media session with the far-end UE 508. In a second scenario, the far-end UE may decide to handover from its serving BS 510 to another BS (not shown), while continuing the media session with the near-end UE 502.

In the LTE standard, traffic flow templates (TFTs) may be used to discriminate between different user payloads. The TFTs may use Internet Protocol (IP) header information (e.g., source and destination IP addresses) and Transmission Control Protocol (TCP) port numbers to filter packets such as Voice over Internet Protocol (VoIP) from web browsing traffic so that each packet can be sent down the respective bearers with appropriate Quality of Service (QoS).

In case the far-end UE 508 is using VoIP, there may be a good chance that the play-out buffer on the far-end UE has not been emptied by the time the traffic flow templates (TFTs) get updated as part of the remote-end session transfer. For certain aspects, a slow-down in playback rate (e.g., using time warping) and/or an increase in the buffer size may be triggered upon reception of the TFT modification message. Slow-down of the playback rate ensures having more data in the buffer to play out during the period of time where the flow of voice frames is interrupted due to inter-RAT mobility procedure (e.g., SRVCC). Therefore, the slowdown can help reduce the voice interruption on the far-end UE.

It should be noted that the far-end UE may use TFT modification message or any other signal or event (depending on the specific protocol/standard that is used in communication between the near-end UE and far-end UE) as a trigger to slow down playback when involved in a media session with a near-end UE who has an expected mobility procedure.

For certain aspects, the near-end UE may use one of the steps of the SRVCC procedure as a trigger to slow down playback rate and/or increase buffering. For example, the near-end UE may trigger upon being instructed to handover, upon being requested to begin measuring neighbor base stations and sending measurement reports, even as early as detecting signal strength of a serving base station has fallen below a threshold level, and/or upon the UE being configured by the base station to begin scanning neighbor base stations and/or start sending measurement reports.

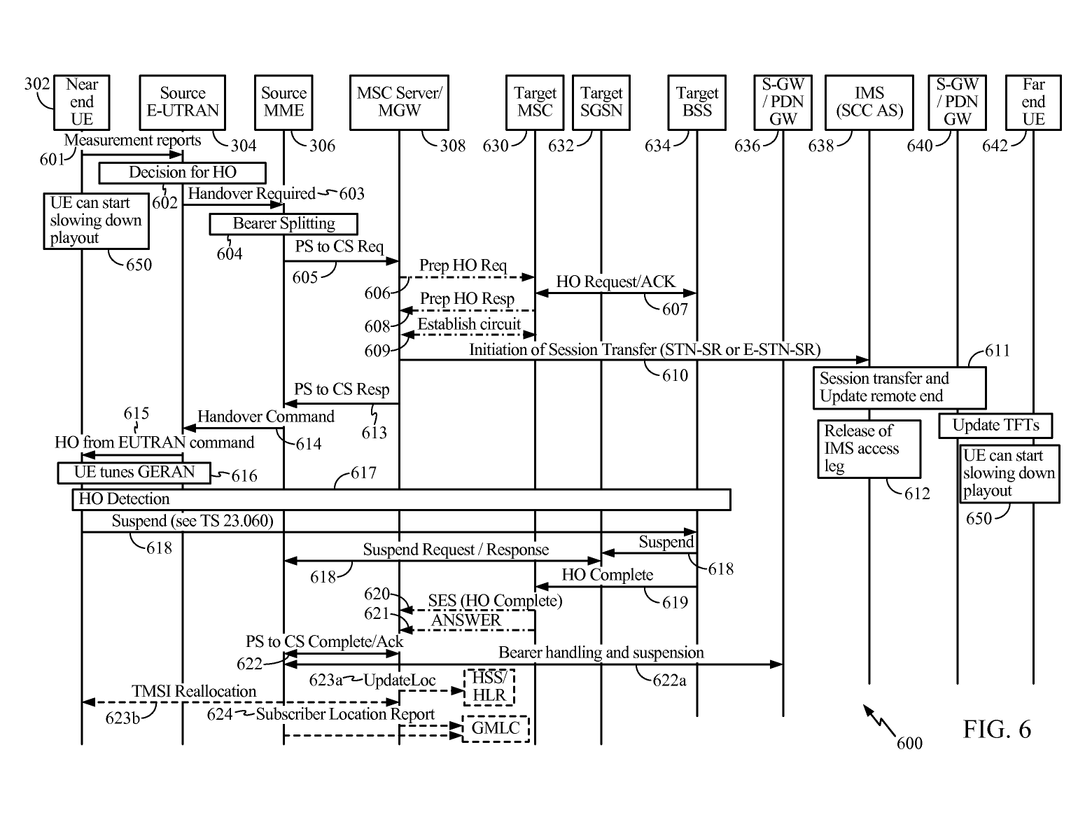

FIG. 6 illustrates how near-end and far-end UEs may detect an event indicating a handover procedure is likely to happen and, in response, begin to slow down play-out of a de-jitter buffer. For example, step 601 of the SRVCC procedure, as illustrated in FIG. 6 (e.g., transmission of measurement report) may be used as a trigger for slowing down the playback rate. The proposed method may result in an increase of buffered data at the near-end UE to play out during SRVCC procedure. For another aspect, the near-end UE may use the handover from E-UTRAN command (e.g., step 615 in FIG. 6) as a trigger for slowing down the playback rate.

For certain aspects, the amount of buffered data could be capped at a certain value (e.g., the maximum buffer size) to make sure too much data is not buffered which can cause problems if the mobility procedure completes faster than it takes to play the amount of buffered data. For certain aspects, minimum and maximum playback rates of the buffer may also be stored at the UE. As an example, the UE may switch to a minimum playback rate upon detecting a mobility procedure.

An example call flow for SRVCC procedure from E-UTRAN to GERAN is illustrated in FIG. 6. At 601, the near-end UE 302 sends measurement reports to source E-UTRAN 304. As described earlier, step 601 may also trigger a slow down in the playback rate of the buffer (e.g., 650) while sending the measurement reports. At 602, based on UE measurement reports, the source E-UTRAN may decide to trigger an SRVCC handover to GERAN. At 603, the source E-UTRAN 304 may send a ‘Handover Required’ message to the source MME 306. The SRVCC handover indication may indicate to the source MME 306 that target is only CS capable, hence a SRVCC handover operation towards the CS domain is being performed.

At 604, based on the SRVCC HO indication, the source MME 306 may split the voice bearer from the non-voice bearers. The source MME 306, may initiate the PS to CS handover procedure for the voice bearer only towards mobile switching center (MSC) Server 308. At 605, the source MME 306 may send a SRVCC PS to CS Request message to the MSC Server 308. At 606, the MSC Server may interwork the PS to CS handover request with a CS inter-MSC handover request by sending a ‘Prepare Handover Request’ message to the target MSC 630. At 607, the target MSC 630 may perform resource allocation with the target base station sub-system (BSS) 634 by exchanging Handover Request/Acknowledge messages. At 608, the target MSC 630 may send a ‘Prepare Handover Response’ message to the MSC Server 308. At 609, the circuit connection may be established between the target MSC 630 and the media gateway (MGW) associated with the MSC Server 308.

At 610, the MSC Server 308 may initiate the Session Transfer by sending a STN-SR (Session Transfer Number for SRVCC) message towards the IMS 638. At 611, during the execution of the Session Transfer procedure the remote-end (far-end UE) may be updated with the Session Description Protocol (SDP) of the CS access leg. The downlink flow of VoIP packets may then be switched towards the CS access leg. At 612, Source IMS access leg may be released. Also, updated TFTs may be sent to the far-end UE 642. For certain aspects, the updated TFTs may be considered as a trigger for slowing down play-out in the far-end UE and increasing the buffer size. At 650, the far-end UE 642 may start slowing down play-out of the buffer after receiving the updated TFTs.

At 613, the MSC Server 308 may send a ‘SRVCC PS to CS Response’ message to the source MME 306. At 614, the source MME 306 may send a ‘Handover Command’ message to the source E-UTRAN 304. At 615, the Source E-UTRAN may send a Handover from E-UTRAN Command message to the near-end UE 302. At 616, the near-end UE 302 may tune to GERAN. At 617, the target BSS 634 may detect the handover. At 618, the UE may start Suspend procedure. This may trigger the Target Serving GPRS Support Node (SGSN) 632 to send a Suspend Request message to the Source MME 306. The source MME may return a Suspend Response to the Target SGSN 632. At 619, the target BSS 634 may send a Handover Complete message to the target MSC 630. At 620, if the target MSC is not the MSC Server, then the Target MSC may send a Handover Complete message to the MSC Server 620.

At 621, target MSC 630 may transmit an Answer message to the MSC Server 308 to indicate completion of the establishment procedure. At 622, the MSC Server 308 may send a SRVCC PS to CS Complete Notification message to the source MME 306, informing it that the near-end UE 302 has arrived on the target side. Source MME 306 acknowledges the information by sending a ‘SRVCC PS to CS Complete Acknowledge’ message to the MSC Server 308. At 623, the MSC Server may perform a MAP Update Location to the Home Location Register/Home Subscriber Server (HLR/HSS), if needed. This may be needed for the MSC Server to receive GSM Supplementary Service information and routing of mobile terminating calls properly in certain configurations. At 624, the source MME may send a subscriber location report to the Gateway Mobile Location Center (GMLC).

It should be noted although in the above example, the UE uses SRVCC procedures while handing over from E-UTRAN to GERAN, the proposed methods for reducing voice interruption during SRVCC procedure may be used while handing over between any two networks.

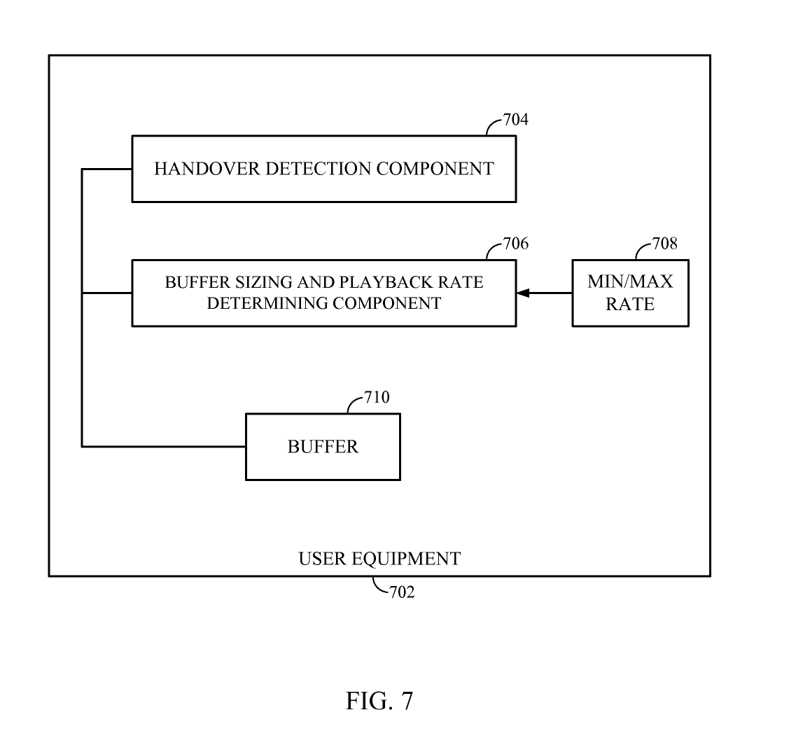

FIG. 7 illustrates an example UE, in accordance with certain aspects of the present disclosure. The UE 702 may be able to reduce voice interruption by performing operations as illustrated in FIG. 4. The UE 702 may include a handover (or other mobility procedure) detection component 704, a buffer sizing and playback rate determining component 706, a memory 708, and a buffer 710.

The handover detection component 704 may detect an event indicating a mobility procedure is likely to occur (e.g., detect a TFT update message for a far-end UE, or detect a measurement report request or other triggering events for a near-end UE). The buffer sizing and playback rate determining component 706 may then increase size of the buffer 710 and/or reduce the rate of play-out sufficient to ensure the buffer does not empty before the expected duration of the anticipated disruption in packet reception due to the mobility procedure.

For certain aspects, when the mobility procedure (e.g., SRVCC) completes, the UE may reduce the buffer size (back to its original size) and/or revert back to its original playback rate for the buffers.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for detecting, means for increasing, means for decreasing and/or means for adjusting may comprise a processing system, which may include one or more processors, such as the processor 270 of the receiver system 250 illustrated in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communications, comprising:
detecting, by a user equipment (UE), an event that indicates an expected disruption in reception of packets is likely to occur during a media session due to an expected mobility procedure; and
in response to the detection, increasing buffering of packets during the session by adjusting size of a buffer used to buffer packets during the media session and decreasing a rate at which packets are transferred from the buffer.

2. The method of claim 1, wherein the media session comprises a voice over internet protocol (VoIP) session.

3. The method of claim 2, wherein the UE is participating in a VoIP session involving a long term evolution (LTE) radio access technology (RAT) network.

4. The method of claim 2, wherein the expected mobility procedure comprises a handover of the UE from a long term evolution (LTE) network to a different radio access technologies (RAT) network.

5. The method of claim 4, wherein the expected mobility procedure comprises a Single Radio Voice Call Continuity (SRVCC) procedure whereby the UE is moved from a long term evolution (LTE) RAT to a different RAT network.

6. The method of claim 5, wherein the different RAT network comprises at least one of a Universal Mobile Telecommunications System (UMTS) or Wideband Code Division Multiple Access (WCDMA) network.

7. The method of claim 5, wherein the different RAT network comprises at least one of a 1x CSFB (Circuit Switched Fall Back) or an extended 1x Circuit Switched Fall Back (e-1xCSFB) network.

8. The method of claim 5, wherein the different RAT network comprises a code division multiple access (cdma2000) 1x network.

9. The method of claim 1, wherein:
the buffer comprises a de jitter buffer; and
decreasing the rate comprises decreasing a rate at which voice over internet protocol (VoIP) packets are played out from the de jitter buffer to a decoder or other type of receiver.

10. The method of claim 1, wherein the media session comprises a video session.

11. The method of claim 1, wherein the mobility procedure comprises an inter-frequency handover of the UE within a same radio access technology (RAT) network.

12. The method of claim 1, wherein the mobility procedure comprises an intra-frequency handover of the UE from a first base station to a second base station.

13. The method of claim 1, wherein the UE is participating in the media session involving at least one of a high rate data packet (HRPD), evolved HRPD (eHRPD), high speed packet access (HSPA), evolved HSPA (eHSPA), or evolved data optimized (EV-DO) radio access technology.

14. The method of claim 1, wherein the UE is participating in the media session involving at least one of a wireless local area network (WLAN) or a Worldwide Interoperability for Microwave Access (WiMAX) network.

15. The method of claim 1, wherein the mobility procedure comprises a handover from a first packet-based radio access technology (RAT) network to a second packet-based RAT.

16. The method of claim 1, wherein the event corresponds to a reduction in signal quality of a serving base station below a threshold value.

17. The method of claim 1, wherein the event corresponds to the UE being configured to send measurement reports.

18. The method of claim 1, wherein the event corresponds to signal quality of a measured neighbor base station exceeding a threshold value.

19. The method of claim 1, wherein the mobility procedure comprises a mobility procedure affecting another UE involved in the media session with the UE.

20. The method of claim 19, wherein the event corresponds to detection of a change in a traffic flow template (TFT) as part of a remote end session transfer.

21. The method of claim 1, wherein increasing buffering of the packets during the session comprises adjusting size of the buffer from a first size to a second size selected to accommodate an expected duration of the expected disruption.

22. The method of claim 1, wherein increasing buffering of the packets during the session comprises reducing the rate at which data is transferred from the buffer by slowing down play-out of the packets to a receiver or decoder to accommodate an expected duration of the expected disruption in the packets during the session.

23. An apparatus for wireless communications, comprising:
means for detecting an event that indicates an expected disruption in reception of packets is likely to occur during a media session due to an expected mobility procedure; and
in response to the detection, means for increasing buffering of packets during the session by adjusting size of a buffer used to buffer packets during the media session and decreasing a rate at which packets are transferred from the buffer.

24. The apparatus of claim 23, wherein the media session comprises a voice over internet protocol (VoIP) session.

25. The apparatus of claim 24, wherein the apparatus is participating in a VoIP session involving a long term evolution (LTE) radio access technology (RAT) network.

26. The apparatus of claim 24, wherein the expected mobility procedure comprises a handover of the apparatus from a long term evolution (LTE) network to a different radio access technologies (RAT) network.

27. The apparatus of claim 26, wherein the expected mobility procedure comprises a Single Radio Voice Call Continuity (SRVCC) procedure whereby the apparatus is moved from a long term evolution (LTE) RAT to a different RAT network.

28. The apparatus of claim 27, wherein the different RAT network comprises at least one of a Universal Mobile Telecommunications System (UMTS) or Wideband Code Division Multiple Access (WCDMA) network.

29. The apparatus of claim 27, wherein the different RAT network comprises at least one of a 1x CSFB (Circuit Switched Fall Back) or an extended 1x Circuit Switched Fall Back (e-1xCSFB) network.

30. The apparatus of claim 27, wherein the different RAT network comprises a code division multiple access (cdma2000) 1x network.

31. The apparatus of claim 23, wherein:
the buffer comprises a de jitter buffer; and
decreasing the rate comprises decreasing a rate at which voice over internet protocol (VoIP) packets are played out from the de jitter buffer to a decoder or other type of receiver.

32. The apparatus of claim 23, wherein the media session comprises a video session.

33. The apparatus of claim 23, wherein the mobility procedure comprises an inter-frequency handover of the apparatus within a same radio access technology (RAT) network.

34. The apparatus of claim 23, wherein the mobility procedure comprises an intra-frequency handover of the apparatus from a first base station to a second base station.

35. The apparatus of claim 23, wherein the apparatus is participating in the media session involving at least one of a high rate data packet (HRPD), evolved HRPD (eHRPD), high speed packet access (HSPA), evolved HSPA (eHSPA), or evolved data optimized (EV-DO) radio access technology.

36. The apparatus of claim 23, wherein the apparatus is participating in the media session involving at least one of a wireless local area network (WLAN) or a Worldwide Interoperability for Microwave Access (WiMAX) network.

37. The apparatus of claim 23, wherein the mobility procedure comprises a handover from a first packet-based radio access technology (RAT) network to a second packet-based RAT.

38. The apparatus of claim 23, wherein the event corresponds to a reduction in signal quality of a serving base station below a threshold value.

39. The apparatus of claim 23, wherein the event corresponds to the apparatus being configured to send measurement reports.

40. The apparatus of claim 23, wherein the event corresponds to signal quality of a measured neighbor base station exceeding a threshold value.

41. The apparatus of claim 23, wherein the mobility procedure comprises a mobility procedure affecting a user equipment involved in the media session with the apparatus.

42. The apparatus of claim 41, wherein the event corresponds to detection of a change in a traffic flow template (TFT) as part of a remote end session transfer.

43. The apparatus of claim 23, wherein increasing buffering of the packets during the session comprises adjusting size of the buffer from a first size to a second size selected to accommodate an expected duration of the expected disruption.

44. The apparatus of claim 23, wherein increasing buffering of the packets during the session comprises reducing the rate at which data is transferred from the buffer by slowing down play-out of the packets to a receiver or decoder to accommodate an expected duration of the expected disruption in the packets during the session.

45. A computer-program product for wireless communications, comprising a non-transitory computer readable medium having instructions stored thereon, the instructions being executable by one or more processors and the instructions comprising:
instructions for detecting, by a user equipment (UE), an event that indicates an expected disruption in reception of packets is likely to occur during a media session due to an expected mobility procedure; and
in response to the detection, instructions for increasing buffering of packets during the session by adjusting size of a buffer used to buffer packets during the media session and decreasing a rate at which packets are transferred from the buffer.

46. An apparatus for wireless communications, comprising at least one processor configured to:
detect an event that indicates an expected disruption in reception of packets is likely to occur during a media session due to an expected mobility procedure, and
in response to the detection, increase buffering of packets during the session by adjusting size of a buffer used to buffer packets during the media session and decreasing a rate at which packets are transferred from the buffer; and
a memory coupled to the at least one processor.
